(19) United States
(12) Patent Application Publication
(10) Pub. No.: US 2019/0090535 A1
(43) Pub. Date: Mar. 28, 2019

(54) HEATED SMOKINGWARE WASHING DEVICE

(71) Applicants: Sarah Niitsuma, Salt Lake City, UT (US); Donovan Niitsuma, Salt Lake City, UT (US)

(72) Inventors: Sarah Niitsuma, Salt Lake City, UT (US); Donovan Niitsuma, Salt Lake City, UT (US)

(21) Appl. No.: 16/113,146

(22) Filed: Aug. 27, 2018

Related U.S. Application Data
(60) Provisional application No. 62/562,861, filed on Sep. 25, 2017.

(51) Int. Cl. A24F 9/12; B08B 9/22

(52) U.S. Cl. CPC A24F 9/12; B08B 2209/032; B08B 9/22

(57) ABSTRACT

A glassware washing system adapted to thoroughly clean the deposits left behind after glassware or other durable material is used for smoking, vaping, or steam distillation.

### THE FIELD OF THE INVENTION

The present invention relates to devices for flushing glassware with fluids in order to clean the glassware. More specifically, the present invention relates to a glassware washing system which can be used to thoroughly clean the deposits left behind after the glassware is used for smoking, vaping, or other vapor distillation methods.

### BACKGROUND

Many types of substances may be smoked or vaporized in pipes or bubblers, including tobacco and certain varieties of salvia. Glass is often preferred for smoking, both for its artistic qualities, and its insulation qualities. Clean glass also does not impart an off-taste to smoked substances, unlike traditional materials such as wooden pipes, and so is preferred by some smokers. Glass may be hand-blown or commercially produced in a variety of shapes and colors for use as pipes, bubblers, and vapor distillation equipment. Other durable materials such as porcelain or stone may also be shaped into pipes and bubblers, however, these materials may not be as artistically interesting, and it is difficult to tell if any clogs or contamination are present within.

Smoke deposits on glass and other durable materials, however, are notoriously difficult to clean. Smoke deposits frequently consist of a highly-adherent (and frequently toxic) mixture of carbon, tar, nicotine, hard water mineral deposits, polycyclic aromatic compounds, and other substances. Smokers who use glass pipes frequently keep a mixture of course rock salt and isopropanol alcohol on hand to clean the deposits from their glassware. However, shaking a mixture of alcohol and salt inside glassware (or porcelain or stone) tends to leave micro-scratches on the inside of the glass or other material, eventually resulting in cloudy glassware, faster adherence of smoke deposits, and more frequent clogging. This damage can destroy the value of custom hand-blown artistic glassware. Moreover, because nicotine is highly mobile across skin barriers, the fluid left over after glassware has been cleaned can be highly toxic if spilled on the skin, and may be difficult to dispose of correctly. Carcinogenic compounds such as polycyclic aromatic hydrocarbons may also be present in high concentration in the salt and isopropanol mixture, and thus the cleaning fluid must be handled and disposed of carefully.

Additionally, salt and isopropanol mixtures may do a poor job of cleaning some types of deposits or resins from glassware, especially if these resins have caked on over the course of several smoking sessions, or have adhered to scratched glassware. Some smokers resort to using shaking substances such as acetone, methanol, glycol ethers, or cleaners with trisodium phosphate inside the glassware, often covering the openings with their hands. This process is dangerous due to the risk of absorption of toxic substances across the skin. Additionally, placing a hand over the opening may cause spills—or even burns, either because users heat the solvents first, or because the solvents are simply caustic. Even once the glassware is clean, users are left with large quantities of toxic fluids, which may be difficult to dispose of properly and which may cause widespread environmental disturbances if disposed of improperly. Trisodium phosphate, for example, can be especially destructive if it reaches wetlands or lakes, and should not be emptied down household drains.

Finally, smokers who use some types of solvents to clean their glassware must be vigilant not to smoke from a pipe until any remaining solvents have off-gassed, a process that may take some time. Repeated transfer of the solvent into and out of a pipe may also result in spillage and evaporation of the solvent, which can be problematic in areas lacking superb ventilation. Prolonged exposure to airborne methanol, for example, may cause blindness. Glycol ethers are sometimes implicated in low fertility and birth defects. The inhalation of most types of solvents is a risk factor for asthma, which smokers may be particularly prone to developing.

One solution to the problem of cleaning smoke deposits from glassware has been to run flexible plastic tubing to one opening of a piece of smoking glassware or smoking hardware, and to attach the hose of a wet/dry shop vacuum to the other end. A user fills the smoking glassware with solvent or solution by pouring the liquid into the free end of the tubing, then may shake the glassware by hand, then the user vacuums the liquid out of the glassware with the shop vacuum. Such ad-hoc setups are highly prone to leaking, especially if the glassware must be shaken while the tubing is attached. The glassware may fall over, causing further spillage. The choice of solvents must be tightly restricted, because many solvents will eat through or corrode plastic tubing, and can damage any vacuum mechanisms with which they come in contact. Additionally, the vacuum applied by the shop vacuum may cause an undesirable level of fluid agitation within the glassware, as the solvent bubbles and is sucked through the glassware violently. This may prove damaging to delicate structures within some types of smoking glassware, such as percolated (or enclosed flowerhead-type) water pipes.

While such shop vacuum systems may be effective in cleaning thin smoke deposits from straight-shaft or uncomplicated types of smoking glassware, it is relatively expensive, because it can be used only for a limited time before internal vacuum parts become corroded. Changing out the dirty washing fluid may be difficult, and when dirty solvent is used to rinse glassware it may not leave the glass as clean, and may be aesthetically displeasing as it flows through clear glassware. Even when non-damaging solvents such as water are used, the carbon tar or resin rinsed from the smoking glassware tends to accumulate on internal components of the vacuum, fouling them, and causing clogs which are difficult to access or clear.

Thus, there is a need for an improved, long-lasting device for cleaning smoking deposits from glassware and other smokingware.

### SUMMARY OF THE INVENTION

Embodiments of an automatic washing system for cleaning smoking deposits off glassware or other smokingware are discussed below. The system includes a variety of inventive aspects which can be used together to reduce the risk of solvent spills, preserve the functioning of the device, make cleaning less damaging and more efficient, and to limit the volume of dirty solvent that must be disposed of. It will be appreciated that various aspects of the invention can be used independently or together and that the invention is set forth in the attached claims rather than the description contained herein.

### BRIEF DESCRIPTION OF THE DRAWINGS

Various embodiments and features of glassware washing systems are shown and described in reference to the following numbered drawings:

FIG. 1 shows a schematic view of a fully assembled smokingware washing device;

FIG. 2 shows a perspective view of an attachment for a smokingware washing device;

FIG. 3 shows a cutaway view of an attachment for a smokingware washing device;

FIG. 4 shows a view of barbed insert for a smokingware washing device.

It will be appreciated that the drawings are illustrative and not limiting of the scope of the invention which is defined by the appended claims. The embodiments shown accomplish various aspects of the invention. It is appreciated that it is not possible to clearly show each element and aspect of an invention in a single figure, and as such, multiple figures are presented to separately illustrate the various details of embodiments of glassware washing systems in greater clarity. Several aspects from different figures may be used in accordance with glassware washing systems in a single structure. Similarly, not every embodiment need accomplish all advantages of various embodiments of a smokingware washing system.

### DETAILED DESCRIPTION

The invention and accompanying drawings will now be discussed in reference to the numerals provided therein so as to enable one skilled in the art to practice the present invention. The skilled artisan will understand, however, that the apparatuses, systems and methods described below can be practiced without employing these specific details, or that they can be used for purposes other than those described herein. Indeed, they can be modified and can be used in conjunction with products and techniques known to those of skill in the art in light of the present disclosure. The drawings and descriptions are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

Reference in the specification to “one configuration” “one embodiment,” “a configuration” or “an embodiment” means that a particular feature, structure, or characteristic described in connection with the configuration is included in at least one configuration, but is not a requirement that such feature, structure or characteristic be present in any particular configuration unless expressly set forth in the claims as being present. The appearances of the phrase “in one configuration” in various places may not necessarily limit the inclusion of a particular element of the invention to a single configuration, rather the element may be included in other or all configurations discussed herein.

Furthermore, the described features, structures, or characteristics of configurations of the invention may be combined in any suitable manner in one or more configurations. In the following description, numerous specific details are provided, such as examples of products or manufacturing techniques that may be used, to provide a thorough understanding of configurations of the invention. One skilled in the relevant art will recognize, however, that configurations of the invention may be practiced without one or more of the specific details, or with other methods, components, materials, and so forth. In other instances, well-known structures, materials, or operations are not shown or described in detail to avoid obscuring aspects of the invention.

Before the present invention is disclosed and described in detail, it should be understood that the present disclosure is not limited to any particular structures, process steps, or materials discussed or disclosed herein, but is intended to include equivalents thereof as would be recognized by those of ordinarily skill in the relevant art. More specifically, the invention is defined by the terms set forth in the claims. It should also be understood that terminology contained herein is used for the purpose of describing particular aspects of the invention only and is not intended to limit the invention to the aspects or configurations shown unless expressly indicated as such. Likewise, the discussion of any particular aspect of the invention is not to be understood as a requirement that such aspect is required to be present apart from an express inclusion of the aspect in the claims.

It should also be noted that, as used in this specification and the appended claims, singular forms such as “a,” “an,” and “the” may include the plural unless the context clearly dictates otherwise. Thus, for example, reference to “a plate” may include one or more of such plates, and reference to “the backing” may include reference to one or more of such layers.

As used herein, the term “substantially” refers to the complete or nearly complete extent or degree of an action, characteristic, property, state, structure, item, or result to function as indicated. For example, an object, such as tubing, that is “substantially” enclosed would mean that the object is either completely enclosed or nearly completely enclosed. The exact allowable degree of deviation from absolute completeness may in some cases depend on the specific context, such that enclosing nearly all of the length of a piece of tubing would be substantially enclosed, even if the distal end of the structure enclosing the tubing had a slit or channel formed along a portion thereof. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it lacked a bottom.

Likewise, the term generally is used to identify a situation in which some is close enough that it would commonly be considered to be a described feature, position, etc., even though it is not exactly so. For example, a structure may be said to be generally vertical even though it is not exactly 90 degrees from the horizontal. In other words, a plate held at an angle 80 degrees above horizontal may be said to be generally vertical. The exact range will be determined by the ordinary usage of a person of ordinary skill in the art.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Concentrations, amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

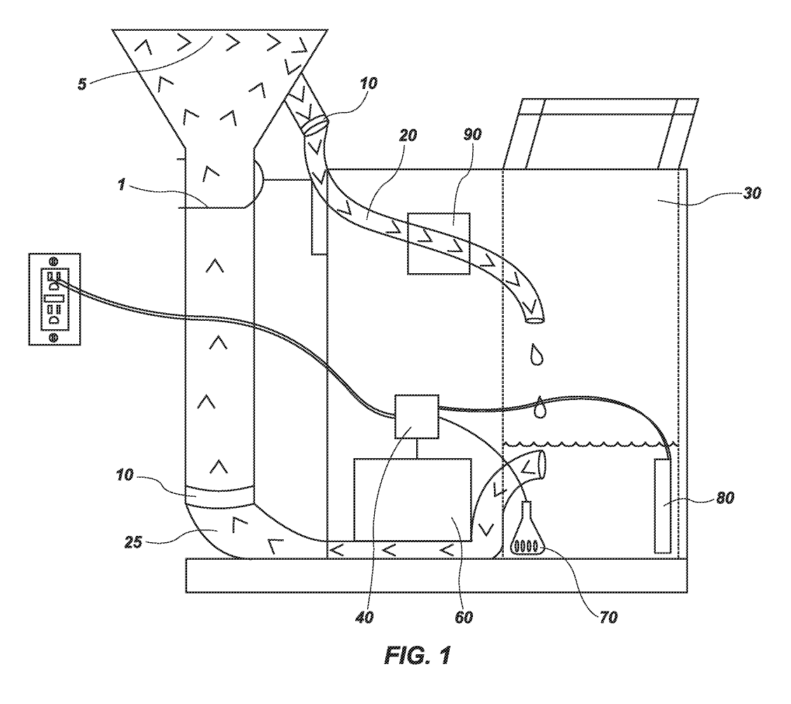

Turning now to FIG. 1 there is shown a schematic rendering of a fully-assembled glass washing device. The device may include means 1 for steadying the glassware or smokingware 5, so that the glassware may be easily inserted into and removed from the glassware washing apparatus. One means of doing so is a padded fork 1, as in the pictured embodiment; however it will be appreciated that other means are possible including clips, a clamp which may be tightened or untightened, or magnets suitable for magnetically engaging a metal ring or band placed around the glassware or other smokingware 5. The means 1 for steadying the glassware 5 may further include lighting, such as LEDS (light emitting diodes), which may be controlled as discussed in further detail below. The lights may engage when the glassware is properly placed in an upright position and appropriate operating conditions have been achieved (proper fluid temperature, fluid level, etc.) as discussed below, so as to provide visual feedback that the glassware cleaning device is ready to be engaged. The lighting may also be arranged so as to make the glassware light up when fluid is flowing through the glassware column, which may be more aesthetically pleasing.

Also shown is the outflow tubing 20, by which dirtied solvent is returned to the reservoir 30. In some embodiments, the outflow tubing may be flexible aluminum, or may be plastic such as HDPE or polypropylene copolymer, or rubber. The outflow tubing may be attachable to the glassware by means of a ring or clamp. A single overflow tube 20 may include a tube-splitter (or y-type connector), or a pair of tubes may be used. In such instances, each tube 20 may empty into a separate reservoir 30, so that the glassware cleaning system can for example run both a main wash and a final rinse through the glassware, or can run two different solvents through the glassware successively, and the like.

In the pictured embodiment, the glassware 5 is held in an upside-down position, however it will be appreciated that the glassware may alternately be cleaned in an upright position. The inflow and outflow tubing may accordingly be reversed.

One problem in existing glassware washers is attaching the tubing 20 to the glassware 5 so as to form a water-tight, releasable junction. In a shop vacuum-type system, the tube or hosing 20 may be pressed over the opening of glassware 5 and held in place with a simple twist-tie. Such ad-hoc junctions tend to leak and are unattractive. One item of glassware, for example, may have openings measuring variously between a half-inch and an inch across, while another piece of glassware may have half-inch and two-inch openings.

To deal with such large variations in glassware size, the presently-disclosed device may include a selection of attachment pieces or ribbed baffles 10 adapted to fit the most common sizes of smoking hardware openings. These may be provided in sizes ranging between approximately 0.5 inches in width, to 3 inches in width.

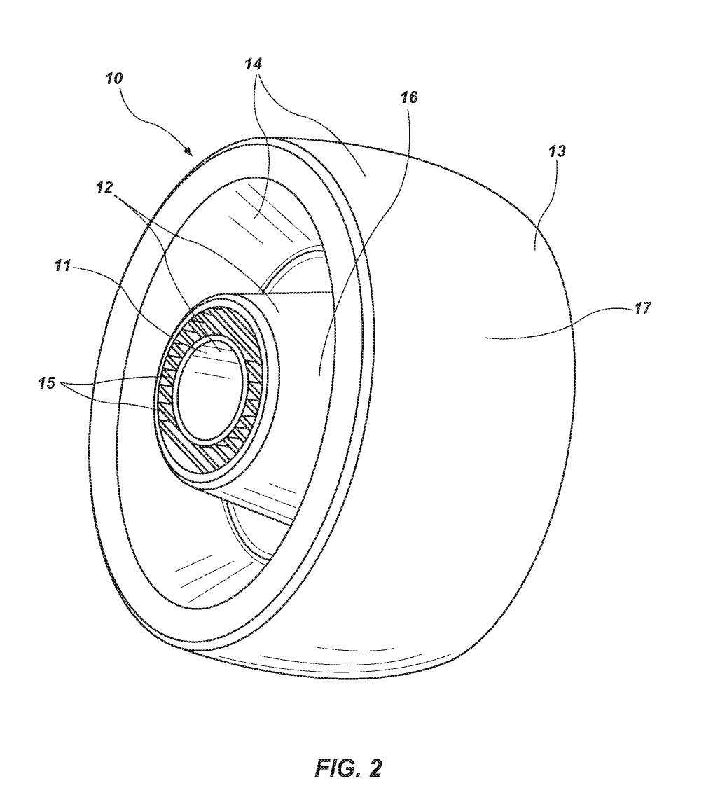

One benefit of some embodiments of the glassware washing device presently disclosed is that, in some configurations, only a few or a single attachment piece or ribbed baffle 10 may be required to accommodate many types and sizes of glassware openings. The multi-size glassware attachment piece or ribbed baffle 10 is described in further detail in FIG. 2.

The outflow tube 20 may pass through or terminate in a removable filter 90. The filter 90 may be a replaceable chamber filled with charcoal, ceramic beads, or other means known to one of skill in the art for filtering contaminants from solvents. The filter may also be a basket-type fitted with a changeable paper filter. Thus, many of the smoking deposits rinsed from the glassware may be caught before they may enter the reservoir and contaminate the rest of the rinsing fluid or solvent.

The glassware washing system may further include one or more reservoirs 30, which may be removable. These reservoirs or chambers 30 may be heated by means of a heating element 70, the action of which may be controlled by an electronics board or control board 40. The heating element 70 may be entirely enclosed, and may wrap around a portion of the reservoir, or may be located underneath the reservoir. The under-reservoir embodiment is particularly useful in embodiments where the entire reservoir 30 may be removed for emptying.

In some embodiments, the control board 40 may be used to cycle the heating element 70 in order to maintain a preferred temperature of the washing solvent. The control board 40 may further control the action of a pump 60, and the level and temperature of the solvent remaining in the reservoir by means of a sensor or sensors 80, which may include for example a thermostat and level sensor. The control board 40 may also track washing cycles, and may report this data to a display (not shown). The control board 40 may be programmed to automatically perform wash cycles—for example, one program may include running a quart of solvent heated to 122 degrees F. from the first reservoir through the glassware, waiting one minute, altering the color of the lights, and then emptying the glassware and running a quart of the second solvent through the glassware at 130 degrees F.

In embodiments capable of containing several different types of solvent or solution, the temperature may be adjustable for maximum effectiveness. For example, when a solvent such as a mix of isopropyl alcohol, sodium lauryl sulfite, and 2-2-butoxyethoxy-ethanol is poured into the reservoir, the user may press buttons on a control panel to indicate that the reservoir contains this solution. Alternately, a sensor inside the reservoir may detect what solvent has been placed inside. The smokingware cleaning device then automatically adjusts the temperature of the reservoir to the most effective temperature for that solvent—about130 degrees F. for some common solvent mixtures, but a lower temperature if the solvent is methanol, etc.

Solvent may flow from the reservoir 30 through input tubing 25. The input tubing or inflow tubing 25 may be attached to the glassware by means of a clamp, a rubber stopper, or similar device (not shown), but in some embodiments the inflow tubing 25 may be attached to the glassware by means of a second ribbed baffle 10 (see also FIG. 2). In some embodiments, it is advantageous if the inflow tubing 25 is a durable, solvent-resistant, flexible material, such as HDPE or polypropylene copolymer. Additionally, it is advantageous if pump elements which contact the solution or solvent may be formed from materials which resist degradation in those solutions.

In other embodiments, the pump 60 may be adapted to roll or squeeze the tubing 25, thus forcing solvent forward through the inflow tubing 25 at a low flow rate. Thus in such embodiments, the solvent or solution (which may carry dissolved tar-like compounds, despite the filtration) may not touch internal mechanisms of the pump 60, extending the useful life of the pump.

An additional advantage of such a pumping and tubing assembly is that solvent flows through the glassware at a low rate of speed, causing minimal bubbling or fluid shearing effects, and avoiding damage to any delicate portions of the glassware.

In some embodiments, the smokingware washing device may be adapted to include an agitation or a drying cycle, or both. In some of these embodiments, a pump 60 capable of cycling air (without causing damage to the pump) may be installed. In use, the pump operates to fill the glassware or other smokingware with solvent or other solution, then bubbles air gradually through the filled glassware in order to provide gentle agitation. After the solution is emptied into one of the reservoir(s) 30, the pump may cycle from the empty reservoir in order to blow air through the cleaned glassware. In other configurations, the agitation cycle may include cycling the same solvent several times through the glassware, during which the pump may operate at varying speeds or volumes, in order to increase fluid agitation without damaging internal components of the smokingware.

Turning now to FIG. 2, there is shown a glassware tubing attachment or ribbed baffle, generally indicated at 10. The attachment piece 10 may be supplied in a graduated variety of sizes, ranging from between about 0.5 inches in width to approximately 3 inches in width, to match the common smokingware opening diameters.

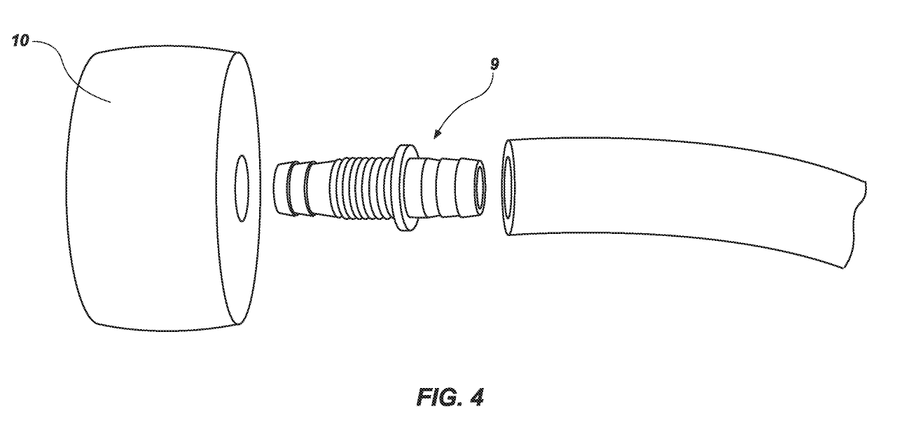

In some embodiments, in order to form a watertight junction between tubing and the opening of a piece of glassware, a user may insert one end (either 11 or 13, whichever matches the diameter of the glassware most closely) of the glassware tubing attachment into the glassware opening. If the end (11 or 13) is slightly smaller than the glassware opening, the ribs (12 or 14) may press against the inside of the glassware and provide a sufficient seal. If the end (11 or 13) is larger than the glassware opening, the end (11 or 13) may be capable of deforming sufficiently to be pressed inside the glassware. Likewise, the tubing (20 or 25, FIG. 1) may then be placed over a portion of the glassware attachment piece 10. Alternately, the glassware attachment piece 10 may include a disposable barbed nozzle (9, FIG. 4). For example, when a small glassware opening must be attached to large tubing, the small end 11 may be inserted into the glassware opening, while the tubing is stretched around the larger end 13. When a large glassware opening should be joined to large tubing, the large end 13 may be inserted into the glassware (up to the broadest body circumference, 17) while the tubing is inserted onto a barbed coupler at the small end 11 which may extend all the way up to the widest body circumference, 17. Similarly, large glassware openings may be attached to small diameters of tubing, etc.

In addition, the glassware attachment piece 10 may include ribbing (12 and 14) both inside a tubing cavity 16 and around the outside of the attachment piece 10. The ribbing (12 and 14) may be small, rigid ridges as shown in FIG. 2, or alternately may be larger or more flexible flanges. The ribbing 12 and 14 may extend perpendicular from the walls of the attachment piece 10, or may be inclined at an angle, so that they flatten to the body of the attachment piece 10 when the attachment piece is pressed into a glassware opening or a length of tubing, but form a tighter seal when a user tugs back on the attachment piece 10.

In addition, the ends 11 and 13 of the attachment piece 10 may be shaped nozzle openings, adapted to (for example) aim or direct the flow of water or air therethrough. For example, the end 11 may include a single channel therethrough, or the channel may be split into smaller openings through which water may exit at increased force.

In an alternate configuration, the attachment piece 10 may be adapted to form a water-tight junction between a range of sizes of tubing and sizes of glassware opening, such that a selection of several (or even a single identical) attachment pieces 10 are needed to attach tubing (FIGS. 1, 20 and 25) to most sizes of glassware. In order to accomplish this functionality, one or more of the end walls of the glassware tubing attachment piece 10 may be supplied with a deformation or resilient layer 15, which may include a honeycomb-like layer of soft plastic, silicone, or similar material 15, or other means known to one of skill in the art of forming a resilient or deformable layer 15.

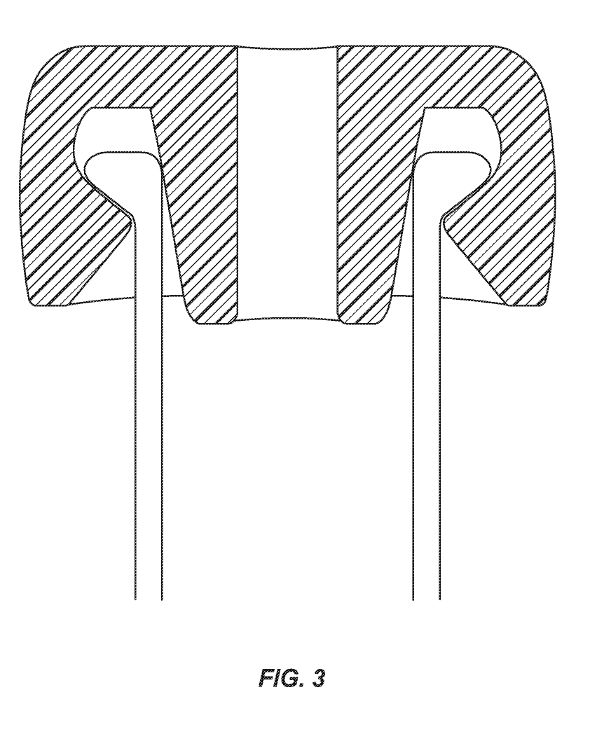

Turning now to FIG. 3, there is shown a cutaway view of an attachment piece 10, which may be one of a set of variously-sized attachment pieces, adapted to fit the various common sizes of glassware openings.

With respect to FIG. 4, there is shown a barbed nozzle 9, which may fit securely inside the attachment piece 10, while providing a robust attachment method for attaching the tubing to the attachment piece. In some embodiments, the barbed nozzle 9 may be formed as one piece with the attachment piece 10, or otherwise permanently attached. In the pictured embodiment however, the barbed nozzle 9 is separate and disposable for ease of cleaning and to reduce the possibility of wear on the barbs.

Thus, there is disclosed a glassware washing system. It will be appreciated that numerous changes may be made to the above-disclosed embodiments of glassware washing devices and associated methods without departing from the scope of the claims. The appended claims are intended to cover such modifications.

What is claimed is:

1. A heated glassware washing system comprising:
a solvent reservoir,
a heating element in communication with the solvent reservoir,
a pump in communication with the solvent reservoir, the pump configured to compress an input tubing to force solvent through the input tubing at a low flow rate;
a glassware supporting member, wherein the glassware supporting member comprises a padded fork,
the input tubing for connecting the solvent reservoir to a piece of glassware to be washed, and
an attachment piece comprising a ribbed baffle for attaching the input tubing to the piece of glassware to be washed, wherein the attachment piece is adapted to form a watertight connection between the input tubing and the piece of glassware to be washed.

2. The heated glassware system of claim 1, further comprising a fluid level sensor for sensing a level of fluid inside the solvent reservoir, and a thermostat adapted for sensing a fluid temperature.

3. The heated glassware system of claim 1, wherein the ribbed baffle has a width, and wherein the ribbed baffle width ranges from about 0.5 inches to about 3 inches.

4. The heated glassware system of claim 3, wherein the piece of glassware to be washed has an opening with a width, and wherein the width of the opening of the piece of glassware to be washed is larger than the width of the ribbed baffle, such that the ribbed baffle may be at least partially received by the opening of the piece of glassware.

5. The heated glassware system of claim 3, wherein the piece of glassware to be washed has an opening with a width, and wherein the width of the opening of the piece of glassware to be washed is larger than the width of the ribbed baffle, and wherein the ribbed baffle is formed of deformable material, such that the ribbed baffle may be at least slightly deformed and at least partially received by the opening of the piece of glassware.

6. A heated glassware washing system comprising:
a solvent reservoir,
a heating element in communication with the solvent reservoir,
a pump in communication with the solvent reservoir,
a glassware supporting member, wherein the glassware supporting member comprises a padded fork,
input tubing for connecting the solvent reservoir to a piece of glassware to be washed, and
an attachment member for attaching the piece of glassware to be washed to the input tubing, wherein the attachment member comprises a barbed nozzle, wherein the barbed nozzle comprises an outer wall and ribbing extending perpendicular to the outer wall at an angle, such that the ribbing flattens to the outer wall when the piece of glassware to be washed is pressed into the attachment member and the ribbing forms a tighter seal when the piece of glassware to be washed is pulled away from the attachment member.

7. The heated glassware washing system of claim 6, wherein the input tubing for connecting the solvent reservoir to a piece of glassware comprises a deformable layer.

8. The heated glassware washing system of claim 7, wherein deformable layer comprises a layer of honey-comb shaped plastic.

9. The system of claim 1, further comprising a fluid level sensor for sensing a level of fluid inside the reservoir, and a thermostat adapted for sensing a fluid temperature.

10. The system of claim 1, wherein the glassware supporting member further comprises lighting.

11. The system of claim 10, wherein the lighting comprises light emitting diodes, and wherein the lighting is adapted to indicate when an item of glassware is connected to the system.

12. The system of claim 1, wherein the system further comprises a second reservoir.

13. The system of claim 1, wherein the system further comprises a filter.

14. The system of claim 13, wherein the filter is removable.

15. The system of claim 1, further comprising a control board.

16. The system of claim 15, wherein the control board is in electronic communication with a sensor, wherein the sensor collects data.

17. The system of claim 16, wherein the control board is in electronic communication with a display, and wherein the display is adapted to report the data collected by the sensor.

18. The system of claim 17, further comprising a heating element, and wherein the control board is in electronic communication with the pump and the heating element, and the control board is adapted to run cleaning programs.

19. A method of cleaning glassware, comprising the steps of:
supplying a piece of glassware to be washed, tubing, and a means for steadying glassware;
selecting the system for washing glassware of claim 1
attaching the piece of glassware to be washed to the solvent reservoir via the input tubing and the attachment piece;
activating the pump to compress the input tubing to force the solvent from the reservoir, through the input tubing, and through the glassware at a low flow rate;
emptying the solvent from the glassware to complete a cleaning cycle; and
indicating when the cleaning cycle is complete.

20. The method of claim 17, wherein the circulating step further comprises circulating the solvent through a filter.
